(19) United States
(12) Patent Application Publication
(10) Pub. No.: US 2026/0205311 A1
(43) Pub. Date: Jul. 16, 2026

(54) INFORMATION PROCESSING APPARATUS, INFORMATION PROCESSING METHOD, AND COMPUTER PROGRAM PRODUCT

(71) Applicants: KABUSHIKI KAISHA TOSHIBA, Kawasaki-shi (JP); TOSHIBA DIGITAL SOLUTIONS CORPORATION, Kawasaki-shi (JP)

(72) Inventors: Mariko TAKAHASHI, Kawasaki Kanagawa (JP); Haruhiko TOYAMA, Kawasaki Kanagawa (JP)

(73) Assignees: KABUSHIKI KAISHA TOSHIBA, Kawasaki-shi (JP); TOSHIBA DIGITAL SOLUTIONS CORPORATION, Kawasaki-shi (JP)

(21) Appl. No.: 19/396,481

(22) Filed: Nov. 21, 2025

(30) Foreign Application Priority Data
Jan. 14, 2025 (JP) 2025-004499

(51) Int. Cl. H04L 9/32; G06N 3/08; H04L 9/00

(52) U.S. Cl. CPC H04L 9/3263; G06N 3/08; H04L 9/50

(57) ABSTRACT

An information processing apparatus according to an embodiment includes a hardware processors. The processors receive, from a terminal device, transmission data that includes attribute information and registration data. The attribute information includes first position and time information and second position and time information. The first position and time information indicates a position and a time at which the registration data is acquired. The second position and time information indicates a position and a time at which the registration data is transmitted. The processors register, for each piece of the transmission data, information based on the corresponding registration data and the corresponding attribute information in a blockchain. The processors obtain, for each piece of the transmission data registered in the blockchain, evaluation information for evaluating validity of the corresponding registration data by analyzing the corresponding attribute information. The processors output the evaluation information.

### CROSS-REFERENCE TO RELATED APPLICATIONS

This application is based upon and claims the benefit of priority from Japanese Patent Application No. 2025-004499, filed Jan. 14, 2025, the entire contents of which are incorporated herein by reference.

### FIELD

Embodiments described herein relate generally to an information processing apparatus, an information processing method, and a computer program product.

### BACKGROUND

In a service using data provided from a user, such as image information, it may be necessary to evaluate validity (certainty) of the provided data. For example, in insurance claim services for car accidents, natural disasters, and the like, it is desirable to prevent invalid claims by evaluating that the provided data is not falsified.

In a social networking service (SNS), it is desirable to evaluate whether or not invalid data such as fake news has been distributed.

### BRIEF DESCRIPTION OF THE DRAWINGS

FIG. 1 is a block diagram of an information processing system according to an embodiment;

FIG. 2 is a diagram illustrating a configuration example of an operation screen;

FIG. 3 is a diagram illustrating an example of a data structure of an image file;

FIG. 4 is a diagram illustrating an example of a data structure of transmission data;

FIG. 5 is a diagram illustrating an example of a data structure of data to be registered in a blockchain;

FIG. 6 is a diagram illustrating an example of a data structure of certificate information;

FIG. 7 is a diagram illustrating an example of a display screen;

FIG. 8 is a flowchart of data registration processing according to the embodiment;

FIG. 9 is a flowchart of evaluation assist processing according to the embodiment; and

FIG. 10 is a hardware diagram of an information processing apparatus according to the embodiment.

### DETAILED DESCRIPTION

An information processing apparatus according to an embodiment includes one or more hardware processors. The hardware processors are configured to receive, from a terminal device, one or more pieces of transmission data each including attribute information and registration data. The attribute information includes first position and time information and second position and time information. The first position and time information indicates a position and a time at which the registration data is acquired. The second position and time information indicates a position and a time at which the registration data is transmitted. The hardware processors are configured to register, for each of the one or more pieces of transmission data, information based on the registration data included in the corresponding piece of transmission data and the attribute information included in the corresponding piece of transmission data in a blockchain. The hardware processors are configured to obtain, for each of the one or more pieces of transmission data registered in the blockchain, evaluation information for evaluating validity of the registration data included in the corresponding piece of transmission data by analyzing the attribute information included in the corresponding piece of transmission data. The hardware processors are configured to output the evaluation information.

Hereinafter, a preferred embodiment of an information processing apparatus according to the present invention will be described in detail with reference to the accompanying drawings.

The embodiment applied to evaluation of data used in an insurance claim service will be mainly described. The system to which the embodiment is applicable is not limited to the insurance claim service and may be any system including the following systems. The embodiment can be widely applied as a system for verifying validity of data provided from various users (for example, evidence photographs or evidence videos).
A social networking service having a function to enable users to read data provided by a certain user

In the insurance claim service, there has been a problem that, for example, a repair agent claims insurance while invalidly increasing damage without notice to an insurance policyholder (insurance claimant). When claiming with image information (photograph) captured by an image capturing device such as a camera, there has been a problem that an irrelevant image or the like is abused, and a problem that position information and time information (hereinafter, position and time information) added to the image information when an image is captured can be falsified later.

As a technique for preventing falsification, there is a technique using an image capturing device that has a function to add a digital certificate in a falsification resistant area. However, many insurance policyholders do not own an image capturing device having such a special function.

The information processing system according to the embodiment has at least the following functions.
(F1) A function to allow insurance policyholders to upload registration data to be registered in a blockchain utilizing a mobile terminal such as a smartphone that is owned and used by many insurance policyholders: The registration data includes, for example, image information captured by an image capturing device. The registration data corresponds to data that may be evidence of an insurance claim. Hereinafter, the registration data may be referred to as evidence data. The image information is associated with additional information indicating captured position and time.
(F2) A function to receive attribute information that includes position and time information included in the additional information on evidence data and position and time information indicating uploading position and time, and to output evaluation information for evaluating the evidence data by using the attribute information: The evaluation information is output to, for example, a terminal device (a personal computer or the like) used by an investigator who checks (evaluates) contents of an insurance claim.
(F3) A function to output information for identifying a user who uploaded: It is possible to check whether the user who uploaded an image is an insurance policyholder or a repairer, and to check consistency with the position and time information.
(F4) A function to register information based on the evidence data and the attribute information in a blockchain that is protected from falsification and transparent to a third party: With this function, a user who uploaded the evidence data (uploader) can be identified. Since evaluation can be performed involving insurance companies, it is possible to make it difficult to perform illegality such as falsification.
(F5) A function to issue registration to the blockchain in a format of a certificate such as a non-fungible token (NFT): With this function, it is possible to guarantee that the evidence data is an original copy and manage transfer of rights even if an insurance company or a repair company is changed.

With the functions described above, it is possible to quickly perform assessment of an insurance claim (insurance assessment) based on the uploaded evidence data. Thus, validity (certainty) of data can be more efficiently evaluated.

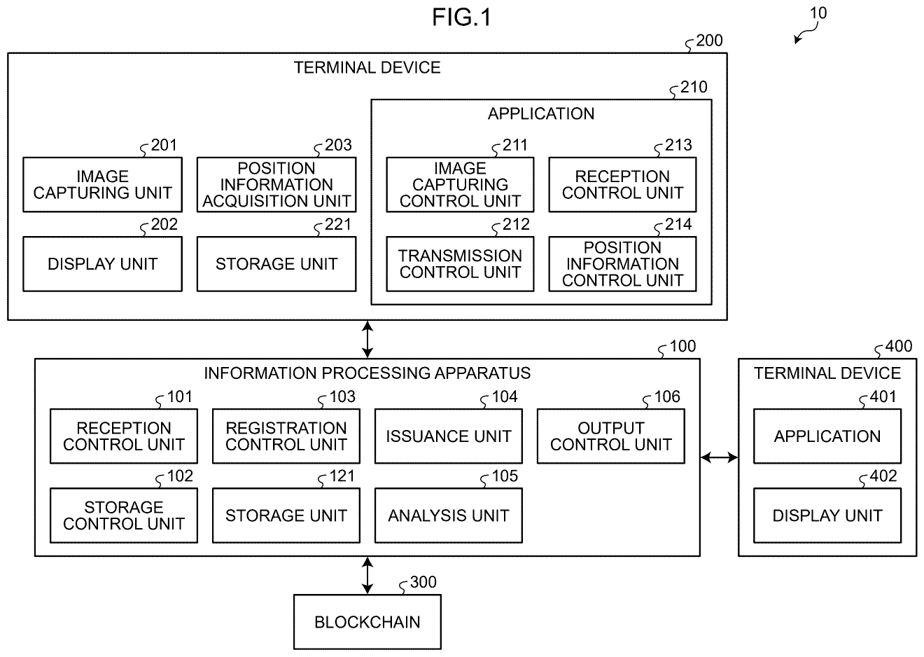

FIG. 1 is a block diagram illustrating an example of a configuration of an information processing system 10 according to the embodiment. As illustrated in FIG. 1, the information processing system 10 includes an information processing apparatus 100, a terminal device 200, a blockchain 300, and a terminal device 400.

The information processing apparatus 100, the terminal device 200, the blockchain 300, and the terminal device 400 are connected to each other via, for example, one or more networks. The network may be a network in any form and may be configured with, for example, the Internet. The network may be any of a wired network, a wireless network, and a combination of wired and wireless networks. The terminal device 200 may be connected to the information processing apparatus 100 via a cloud service or the like.

First, a function of the terminal device 200 will be described. The terminal device 200 is a device having a function to transmit (upload) evidence data to the information processing apparatus 100. The terminal device 200 may be, for example, a portable terminal such as a smartphone.

The terminal device 200 is assumed to be used by a user such as an insurance policyholder or a repairer. In FIG. 1, the information processing system 10 includes one terminal device 200, whereas may include two or more terminal devices 200. The information processing system 10 may include different terminal devices 200 for different users (insurance policyholder and repairer).

The terminal device 200 includes an image capturing unit 201, a display unit 202, a position information acquisition unit 203, a storage unit 221, and an application 210.

The image capturing unit 201 is an image capturing device that serves to capture image information to be used as evidence data. The image information may be a still image or a video image.

The display unit 202 is a display device that serves to display various types of information and is implemented by a liquid crystal display, a touch panel, and the like.

The position information acquisition unit 203 is a device that that serves to acquire position information and is implemented by a global positioning system (GPS) receiver or the like.

The storage unit 221 stores various types of information to be used in the terminal device 200. For example, the storage unit 221 stores the image information captured by the image capturing unit 201.

The application 210 implements a function to capture the image information and upload the image information to the information processing apparatus 100 as evidence data. The application 210 displays an operation screen on the display unit 202 and implements the above function on the operation screen.

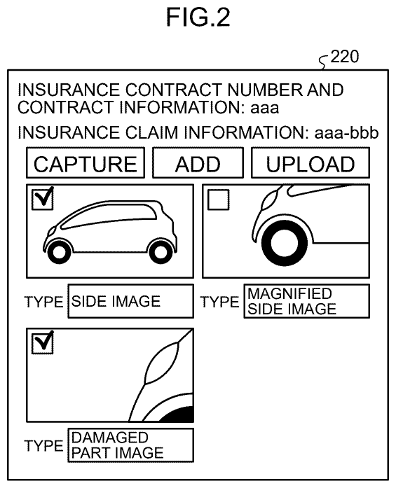

FIG. 2 is a diagram illustrating a configuration example of an operation screen 220. The operation screen 220 includes an insurance contract number and contract information, insurance claim information, a capture button, an add button, an upload button, and one or more image display areas. The image display area may include an input area into which attribute information indicating a type of the image is input. An input method may be implemented by a method such as: text input, selection from a list, or designation of a position on a drawing or an image. The input method may be implemented by a combination of some methods.

The insurance contract number and contract information are, for example, information for identifying an insurance contract input by a user. The insurance claim information is, for example, identification information for identifying an insurance claim input by the user. The insurance claim information may be input after evidence data is uploaded.

The capture button is a button for capturing image information by using the image capturing unit 201. The add button is, for example, a button for selecting image information that is different from the image information captured by the capture button and is stored in the storage unit 221 as a target to be uploaded. The upload button is a button for uploading the selected image information as evidence data to the information processing apparatus 100.

Note that, since added image information can be uploaded, for example, image information in which position and time information and the like are falsified outside of the terminal device 200 can be collected into the storage unit 221 of the terminal device 200, and the collected image information can be uploaded. Such illegality may not be found by comparing position and time information on the image information with uploading position and time information. Therefore, in an insurance claim, a function in which uploading of image information captured by the image capturing unit 201 using the application 210 is mandatory may be provided. If a function to analyze validity of the image information by using the pieces of image information is further provided, possibility of falsification of the added image information can be evaluated by a result of comparing the captured image information with the added image information.

The image display area is an area for displaying the captured image information and the added image information. A checkbox in the image display area allows to select image information to be uploaded.

The description refers back to FIG. 1. The application 210 includes an image capturing control unit 211, a transmission control unit 212, a reception control unit 213, and a position information control unit 214.

The image capturing control unit 211 controls capturing of image information by the image capturing unit 201. For example, when the capture button on the operation screen 220 is operated, the image capturing control unit 211 captures image information by using the image capturing unit 201. The image capturing control unit 211 stores an image file including the captured image information in the storage unit 221.

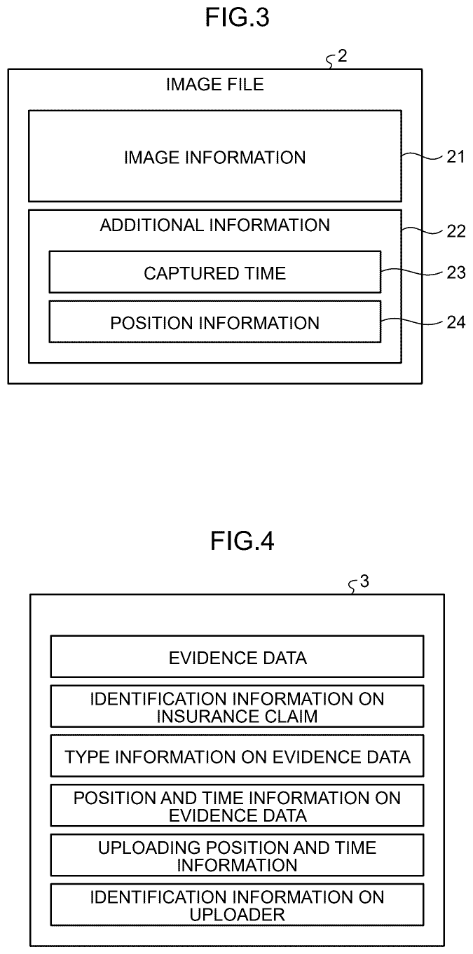

FIG. 3 is a diagram illustrating an example of a data structure of an image file 2. The image file 2 includes image information 21 and additional information 22. The additional information 22 is information added to the image information 21. For example, metadata defined in accordance with a standard such as exchangeable image file format (EXIF) can be used as the additional information 22. The additional information 22 includes captured time 23 and position information 24. The captured time 23 and the position information 24 correspond to the position and time information. Note that the additional information 22 may further include information other than the captured time 23 and the position information 24 (also referred to as “position and time information”).

The captured time 23 may be time information that is based on a clock in the terminal device 200 or time information that is obtained by a GPS function installed in the terminal device 200.

The position information 24 may be information obtained as a geotag. The position information 24 may be information acquired by a GPS function. The position information 24 is defined by, for example, latitude and longitude.

The description refers back to FIG. 1. The transmission control unit 212 controls transmission of information from the terminal device 200. For example, when the upload button on the operation screen 220 is operated, the transmission control unit 212 transmits transmission data including selected evidence data to the information processing apparatus 100. At that time, the position information control unit 214 adds uploading position and time information that was acquired by the position information acquisition unit 203 as attribute information to the data transmitted by the transmission control unit 212.

FIG. 4 is a diagram illustrating an example of a data structure of transmission data 3. The transmission data 3 includes the following elements.
(EA1) Evidence data: Selected image information
(EA2) Identification information on an insurance claim: Identification information for identifying the insurance claim. For example, information input as insurance claim information via the operation screen 220 can be used as the identification information.
(EA3) Type information on evidence data: A type of captured image information, a type of an uploader, and the like. The type of the image information indicates, for example, from which direction (front, side, rear, and the like) of a captured target the image information is captured, whether the image information is magnified or downsized, and the like. The type of the uploader indicates, for example, whether the uploader is an insurance policyholder or a repairer.
(EA4) Position and time information on evidence data: Position and time information IA included in the additional information on the image information as the evidence data (first position and time information).
(EA5) Uploading position and time information: Position and time information IB indicating a position and a time at which the evidence data is uploaded (second position and time information).
(EA6) Identification information on uploader: Information for identifying the uploader. The identification information on the uploader is, for example, a user ID of the user of the terminal device 200, and the identification information is different when the terminal device 200 is different.

The type information on the evidence data, the position and time information IA on the evidence data, the uploading position and time information IB, and the identification information on the uploader correspond to the attribute information. Thus, the transmission data 3 is information including the attribute information and the evidence data. The attribute information is not limited to the above description, and may be any other type of information as long as the information indicates an attribute of the evidence data. In one example, when weather information during capturing or uploading is obtained, the weather information may be included in the attribute information.

Two or more pieces of evidence data may be uploaded for one insurance claim. Those pieces of evidence data may be uploaded over multiple times or may be uploaded at one time. When uploading at one time, the transmission data 3 may be configured to include (EA1), (EA3), and (EA4) among the above-listed elements by the number of pieces of evidence data. The evidence data is not uploaded only by an insurance policyholder and may be additionally uploaded also by a repairer.

The description refers back to FIG. 1. The reception control unit 213 controls reception of information transmitted to the terminal device 200. For example, the reception control unit 213 receives a certificate issued by the information processing apparatus 100.

The certificate is information issued for the evidence data registered in the blockchain 300. When the evidence data is retransmitted to the information processing apparatus 100, the certificate may be included in the attribute information and transmitted. By referring to the certificate included in the attribute information, it is possible to confirm that the retransmitted evidence data is the original copy.

At least some of units included in the application 210 may be implemented by one or more processing units. The above-described each unit is implemented by, for example, one or more processors. The above-described each unit may be implemented by causing a hardware processor such as a central processing unit (CPU) and a graphics processing unit (GPU) to execute a computer program, namely, implemented by software. The above-described each unit may be implemented by a processor such as a dedicated integrated circuit (IC), namely, implemented by hardware. The above-described each unit may be implemented by a combination of software and hardware. When two or more processors are used, each processor may implement one unit or may implement two or more units among the units.

Next, a function of the information processing apparatus 100 will be described. The information processing apparatus 100 includes a reception control unit 101, a storage control unit 102, a registration control unit 103, an issuance unit 104, an analysis unit 105, an output control unit 106, and a storage unit 121.

The reception control unit 101 controls reception of information transmitted to the information processing apparatus 100. For example, the reception control unit 101 receives one or more pieces of transmission data transmitted (uploaded) from the terminal device 200. As described above, each of the one or more pieces of transmission data is information including the attribute information on the evidence data (registration data and image information) and the evidence data.

When the attribute information includes the certificate, the reception control unit 101 may receive transmission data including the attribute information including the certificate. The pieces of transmission data may be transmitted from different terminal devices 200. For example, the reception control unit 101 may receive pieces of transmission data including transmission data transmitted from the terminal device 200 (a first terminal device) used by a certain user and transmission data transmitted from the terminal device 200 (a second terminal device) used by another user.

The storage control unit 102 controls storage of various types of information in the storage unit 121. For example, the storage control unit 102 stores the transmission data received from the terminal device 200 in the storage unit 121. The storage control unit 102 may store each piece of received transmission data (evidence data) in the storage unit 121 or may store combined evidence data for each insurance claim in the storage unit 121.

The registration control unit 103 controls registration of information in the blockchain 300. For example, the registration control unit 103 registers information based on evidence data (registration data) included in the transmission data and attribute information included in the transmission data in the blockchain 300 for each of one or more pieces of transmission data stored in the storage unit 121.

The information based on the evidence data is, for example, a hash value of the evidence data. The hash value is calculated by, for example, an algorithm of SHA 256, and may be calculated by any other method. By using the hash value, it is possible to improve confidentiality of the registered information and reduce a size of the registered information. The information based on the evidence data may be the evidence data itself.

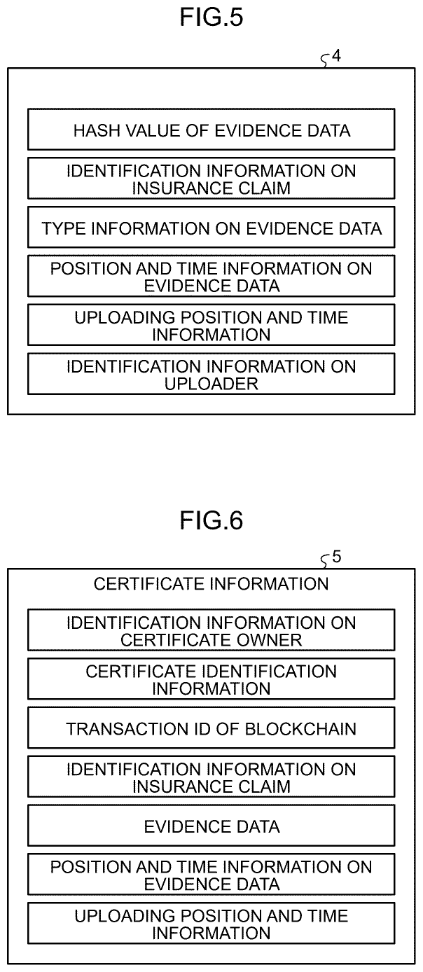

FIG. 5 is a diagram illustrating an example of a data structure of data 4 registered in the blockchain 300. The data 4 includes elements similar to those of the transmission data 3 of FIG. 4 except that the data 4 includes a hash value of the evidence data instead of the evidence data.

The data 4 may be registered in the blockchain 300 as data for each piece of evidence data or may be registered in the blockchain 300 as data obtained by combining pieces of evidence data. A unit of combining pieces of evidence data may be optionally set and is, for example, a unit of insurance claim or a unit of uploading.

By registering in the blockchain 300, evidence data can be ensured as not falsified. Since a third party can confirm the presence, transparency can be secured.

The description refers back to FIG. 1. The issuance unit 104 issues a certificate indicating that evidence data is registered in the blockchain 300. For example, the issuance unit 104 issues a certificate of the registered evidence data and transmits the issued certificate to (the terminal device 200 used by) the uploader or the insurance policyholder.

The certificate may be in any form and is, for example, NFT. The NFT can be non-transferable or can be transferable (owner can be changed). When the NFT is transferable and at least one of the repairer and the insurance company is changed, it is possible for a changed repairer or company to inherit the certificate and the evidence data for which the certificate is issued.

FIG. 6 is a diagram illustrating an example of a data structure of certificate information 5 indicating an issued certificate. The certificate information 5 includes the following elements.
(EB1) Identification information on certificate owner: Information for identifying an owner of the certificate
(EB2) Certificate identification information: Information for identifying the certificate
(EB3) Transaction ID of blockchain 300: Identification information on a transaction allocated by the blockchain 300
(EB4) Identification information on insurance claim
(EB5) Evidence data: Evidence data registered in blockchain 300
(EB6) Position and time information on evidence data
(EB7) Uploading position and time information

For identifying the certificate, at least one of (EB2) Certificate identification information and (EB3) Transaction ID of blockchain 300 needs to be included in the certificate information 5. The certificate information 5 may not include (EB5) Evidence data registered in blockchain 300.

The certificate information 5 may be provided as a file format. The certificate information 5 may be provided in a format including only information associated with the evidence data registered in the blockchain 300, such as NFT.

The description refers back to FIG. 1. The analysis unit 105 analyzes attribute information included in transmission data for each of one or more pieces of transmission data registered in the blockchain 300, thereby obtaining and outputting evaluation information for evaluating validity of evidence data (registration data) included in the transmission data.

The analysis unit 105 analyzes the transmission data (evidence data and attribute information) registered in the blockchain 300. The analysis unit 105 may analyze the transmission data stored in the storage unit 121. When the hash value of the evidence data is registered in the blockchain 300, the analysis unit 105 may use the hash value to confirm that the evidence data stored in the storage unit 121 is not falsified and use the evidence data confirmed to be not falsified in analysis.

The evaluation information is output (transmitted or displayed) to the terminal device 400 by the output control unit 106. As a result, it is possible to assist evaluation (or determination, confirmation, etc.) of the validity of the evidence data by the user of the terminal device 400 (for example, an investigator).

The evaluation information is obtained by, for example, at least some of the following methods.
The analysis unit 105 obtains, as evaluation information, a difference between the position and time information IA and the position and time information IB. The difference may be classified into a distance (difference) for each piece of position information and a distance (difference) for each piece of time information, or may be a distance in a four-dimensional space including three-dimensional position information and one-dimensional time information.
The analysis unit 105 obtains evaluation information by using a learned model (a neural network model or the like) that outputs evaluation information in response to input of the position and time information IA and the position and time information IB. In one example, the model is trained to output an index (confidence degree and reliability degree) indicating higher validity (certainty) of the evidence data as evaluation information when a difference (distance) between the position and time information IA and the position and time information IB is smaller. The neural network model may be trained to output the evaluation information in response to input of at least one of the attribute information and the registration data in addition to the position and time information IA and the position and time information IB.
When pieces of transmission data (evidence data) are obtained, the analysis unit 105 obtains evaluation information including information for evaluating the validities of the whole pieces of transmission data. In one example, the analysis unit 105 obtains evaluation information by using a learned model that outputs, as the evaluation information, an index indicating validity of the whole pieces of transmission data in response to input of pieces of the position and time information IA and the position and time information IB for the pieces of transmission data.
When attribute information including a certificate is transmitted, the analysis unit 105 obtains evaluation information further including an evaluation result by the certificate. The evaluation result by the certificate indicates, for example, whether the evidence data is confirmed to be the original copy by the certificate. The evaluation result by the certificate may include, for example, a comparison result between (a matching result of) the identification information on the certificate owner included in the certificate and the uploader (sender) of the transmission data (evidence data).

The model may be configured such that information other than the position and time information is input. Examples of the information other than the position and time information include the following information.
Evidence data (image information)
Type information on evidence data
Identification information on uploader
Weather Information

The model is trained to output an index in response to input of the image information, the position and time information IA, and the position and time information IB. In the image information, a time may be estimated from brightness and information with which a position can be determined may be estimated from a captured object. Therefore, it is possible to learn the model to output an index indicating higher validity of the evidence data when the difference between the estimated information and the position and time information is smaller. Similarly, the model for evaluating the validity of the whole pieces of transmission data may be configured such that pieces of evidence data (image information) are input.

The analysis unit 105 may evaluate the validity (certainty) of the evidence data by using the distance (difference) and the index, and output the evaluation information indicating the evaluation result. In one example, the analysis unit 105 may output evaluation information indicating that validity (certainty) of evidence data is not confirmed when the calculated distance is larger than a threshold determined in advance as a value that can be interpreted as obviously illegal.

The output control unit 106 controls output of various types of information used in the information processing apparatus 100. The information output method may be any method, and for example, a method of displaying on a display device or a method of transmitting information to an external device via a network can be applied. The output control unit 106 outputs the evaluation information obtained by the analysis unit 105 to the terminal device 400.

At least some of the above-described units (reception control unit 101, registration control unit 103, storage control unit 102, issuance unit 104, analysis unit 105, and output control unit 106) may be implemented by one or more processing units. The above-described each unit is implemented by, for example, one or more processors. The above-described each unit may be implemented by causing a hardware processor such as a central processing unit (CPU) and a graphics processing unit (GPU) to execute a computer program, namely, implemented by software. The above-described each unit may be implemented by a hardware processor such as a dedicated integrated circuit (IC), namely, implemented by hardware. The above-described each unit may be implemented by a combination of software and hardware. When two or more processors are used, each processor may implement one unit or may implement two or more units among the units.

The storage unit 121 stores various types of information used in the information processing apparatus 100. For example, the storage unit 121 stores the transmission data received from the terminal device 200 under control of the storage control unit 102.

The information processing apparatus 100 may be physically configured with one apparatus or may be physically configured with two or more apparatuses. In one example, the information processing apparatus 100 can be constructed on a cloud environment. The units of the information processing apparatus 100 may be distributed in plural apparatuses.

Next, a function of the blockchain 300 will be described. The blockchain 300 is a system that stores data to be distributed in plural ledgers (terminals and peers). By registering the evidence data in the blockchain 300, it is possible to protect the evidence data from falsification. Since transparency to a third party can be secured, even when an insurance company or the like is changed, a function to take over and process the evidence data can be easily implemented.

Next, a function of the terminal device 400 will be described. The terminal device 400 is, for example, a device having a function to assist evaluation of evidence data for insurance assessment by an investigator. The terminal device 400 may be, for example, a terminal device such as a personal computer.

The terminal device 400 is assumed to be used, for example, by a user such as an investigator who performs insurance assessment. In FIG. 1, the information processing system 10 includes one terminal device 400, and may include two or more terminal devices 400.

The terminal device 400 includes an application 401 and a display unit 402.

The display unit 402 is a display device for displaying various types of information and is implemented by a liquid crystal display, a touch panel, and the like.

The application 401 implements a function to assist evaluation of evidence data. For example, the application 401 displays a display screen including evaluation information output by the output control unit 106 of the information processing apparatus 100 on the display unit 402.

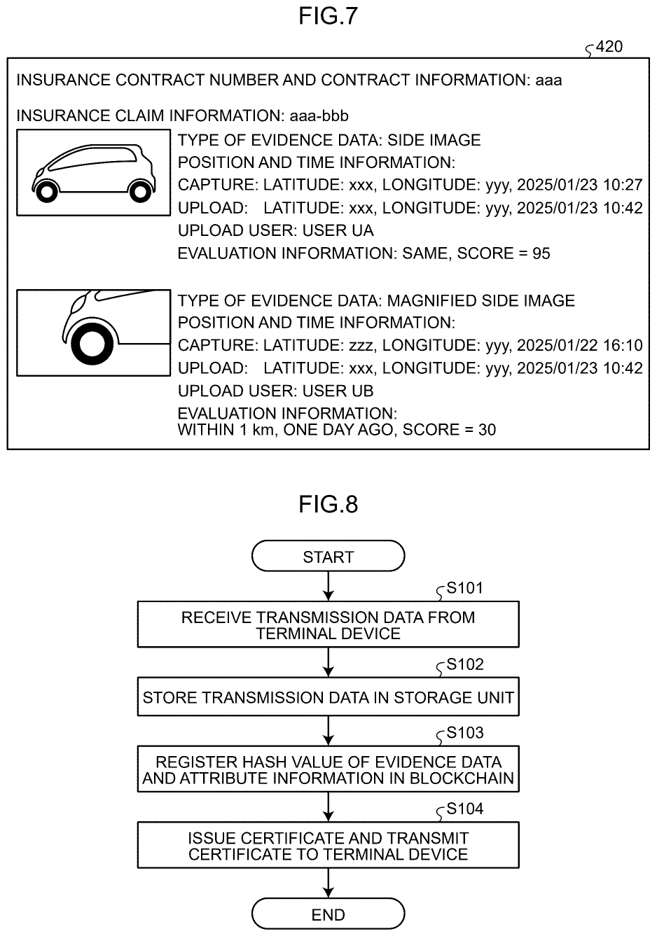

FIG. 7 is a diagram illustrating an example of a display screen 420. In the display screen 420, insurance contract number and contract information, insurance claim information, one or more image display areas, and the like are displayed.

The insurance contract number, contract information, and the insurance claim information are information for determining an insurance claim to be evaluated, the information that is input by an investigator. In one example, data (attribute information or the like) corresponding to the input insurance claim information (identification information on insurance claim) is acquired from the blockchain 300 and used for analysis by the analysis unit 105. The evidence data (image information) corresponding to the insurance claim information is acquired from the storage unit 121 or the blockchain 300 and displayed on the display screen 420.

The type, the position and time information, the upload user, and the evaluation information on the evidence data are displayed in association with each other as the image information displayed in the image display area. In the example of FIG. 7, evaluation information indicating a comparison result between the position and time information during capturing that is the position and time information IA and the uploading position and time information IB of the evidence data is displayed. A score indicates, for example, a confidence degree or a value based on the confidence degree. As such, by referring to evaluation information based on the pieces of position and time information, the user (investigator) of the terminal device 400 can more efficiently evaluate validity (certainty) of the evidence data. A link destination of the recorded blockchain or information recorded in the blockchain may be displayed so that the user can efficiently confirm that the data is not falsified.

The application 401 may be implemented by one or more processing units. The application 401 is implemented by, for example, one or more processors. The application 401 may be implemented by causing a hardware processor such as a central processing unit (CPU) and a graphics processing unit (GPU) to execute a computer program, namely, implemented by software. The application 401 may be implemented by a hardware processor such as a dedicated integrated circuit (IC), namely, implemented by hardware. The application 401 may be implemented by a combination of software and hardware.

Note that the storage unit (storage unit 221 and storage unit 121) of each device may be configured with any general storage medium such as a flash memory, a memory card, a random access memory (RAM), a hard disk drive (HDD), and an optical disk. Part of or all the data stored in the storage unit may be stored in physically different storage media or may be stored in different storage areas of one physical storage medium.

Next, data registration processing by the information processing apparatus 100 according to the embodiment will be described. The data registration processing is processing of registering transmission data (evidence data) transmitted from the user in the blockchain 300. FIG. 8 is a flowchart illustrating an example of the data registration processing according to the embodiment.

The reception control unit 101 receives transmission data uploaded from the terminal device 200 (step S101). The storage control unit 102 stores the transmission data received from the terminal device 200 in the storage unit 121 (step S102). The registration control unit 103 registers, in the blockchain 300, a hash value of evidence data included in the transmission data and attribute information included in the transmission data (step S103). The issuance unit 104 issues a certificate indicating that the evidence data has been registered in the blockchain 300 and transmits the issued certificate to the terminal device 200 (step S104).

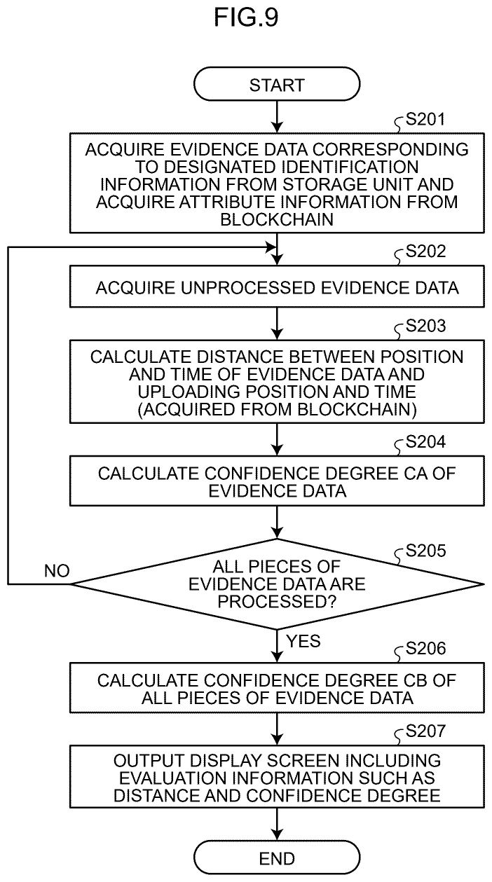

Next, evaluation assist processing by the information processing apparatus 100 according to the embodiment will be described. The evaluation assist processing is processing for assisting evaluation processing of the evidence data performed by a user (investigator or the like). FIG. 9 is a flowchart illustrating an example of the evaluation assist processing according to the embodiment.

The analysis unit 105 acquires evidence data and attribute information corresponding to identification information on an insurance claim designated by a user (investigator and the like) of the terminal device 400 (step S201). In one example, the analysis unit 105 acquires, from the blockchain 300, the attribute information corresponding to the identification information on the designated insurance claim. The analysis unit 105 reads the evidence data corresponding to the identification information on the designated insurance claim from the storage unit 121. The analysis unit 105 may acquire a hash value of the evidence data corresponding to the identification information on the insurance claim from the blockchain 300, compare the acquired hash value with the hash value of the evidence data read from the storage unit 121, and execute subsequent processing when the hash values match each other.

The analysis unit 105 acquires unprocessed evidence data (step S202). The analysis unit 105 calculates a distance (difference) between the position and time information IA included in the additional information on the evidence data acquired from the storage unit 121 and the uploading position and time information IB included in the attribute information acquired from the blockchain 300 (step S203). The analysis unit 105 calculates a confidence degree CA of the evidence data by using a model (step S204).

The analysis unit 105 determines whether all pieces of evidence data corresponding to the identification information on the designated insurance claim have been processed (step S205). When not all pieces of evidence data have been processed (step S205: No), the analysis unit 105 returns to step S202 and repeats the processing for the next unprocessed piece of evidence data.

When all pieces of evidence data have been processed (Step S205: Yes), the analysis unit 105 calculates a confidence degree CB for the whole pieces of evidence data (Step S206). In one example, the analysis unit 105 calculates the confidence degree CB by using a learned model that outputs the confidence degree CB as an index indicating the validity of the whole pieces of evidence data in response to input of pieces of the position and time information IA and the position and time information IB for all pieces of evidence data.

The output control unit 106 outputs a display screen including the distance calculated in step S203, the confidence degree CA calculated in step S204, and the confidence degree CB calculated in step S206 as the evaluation information, for example, to the terminal device 400 (step S207). The output control unit 106 may further output information stored in the storage unit 121 and information registered in the blockchain 300. Accordingly, for example, consistency between two pieces of information can be confirmed.

Note that the evaluation information may be at least one of the distance calculated in step S203, the confidence degree CA calculated in step S204, and the confidence degree CB calculated in step S206.

As such, the information processing apparatus according to the embodiment can more efficiently evaluate the validity (certainty) of the evidence data (registration data and image information) used for the insurance claim or the like.

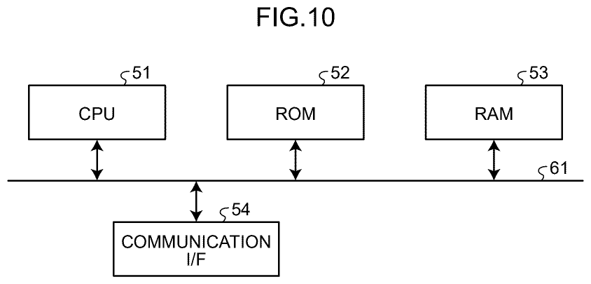

Next, a hardware configuration of the information processing apparatus according to the embodiment will be described with reference to FIG. 10. FIG. 10 is an explanatory diagram illustrating the hardware configuration example of the information processing apparatus according to the embodiment.

The information processing apparatus according to the embodiment includes a control device such as a central processing unit (CPU) 51, a storage device such as a read only memory (ROM) 52 or a random access memory (RAM) 53, a communication I/F 54 connected to a network for communication, and a bus 61 that connects between each unit.

A computer program executed by the information processing apparatus according to the embodiment is provided by being incorporated in the ROM 52 or the like in advance.

The program executed by the information processing apparatus according to the embodiment may be provided as a computer program product that is obtained by recording the program with a file in an installable or executable format on a non-transitory computer readable recording medium such as a compact disk read only memory (CD-ROM), a flexible disk (FD), a compact disk recordable (CD-R), or a digital versatile disk (DVD).

The program executed by the information processing apparatus according to the embodiment may be stored in a computer connected to a network such as the Internet and provided by downloading via the network. The program executed by the information processing apparatus according to the embodiment may be configured to be provided or distributed via a network such as the Internet.

The program executed by the information processing apparatus according to the embodiment may cause a computer to function as each unit of the information processing apparatus described above. In the computer, the CPU 51 can read a computer program from a computer-readable storage medium onto a main storage device and execute the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
one or more hardware processors configured to
receive, from a terminal device, one or more pieces of transmission data each including attribute information and registration data, the attribute information including first position and time information and second position and time information, the first position and time information indicating a position and a time at which the registration data is acquired, the second position and time information indicating a position and a time at which the registration data is transmitted;
register, for each of the one or more pieces of transmission data, information based on the registration data included in the corresponding piece of transmission data and the attribute information included in the corresponding piece of transmission data in a blockchain;
obtain, for each of the one or more pieces of transmission data registered in the blockchain, evaluation information for evaluating validity of the registration data included in the corresponding piece of transmission data by analyzing the attribute information included in the corresponding piece of transmission data; and
output the evaluation information.

2. The information processing apparatus according to claim 1, wherein the hardware processors are configured to
store, in a memory, the registration data included in the transmission data, and
additionally output information stored in the memory and information registered in the blockchain.

3. The information processing apparatus according to claim 1, wherein the hardware processors are configured to obtain, as the evaluation information, a difference between the first position and time information and the second position and time information.

4. The information processing apparatus according to claim 1, wherein the hardware processors are configured to obtain the evaluation information by using a neural network model having been trained to output the evaluation information in response to input of the first position and time information and the second position and time information.

5. The information processing apparatus according to claim 4, wherein the neural network has been trained to output the evaluation information in response to input of at least one of the attribute information and the registration data in addition to the first position and time information and the second position and time information.

6. The information processing apparatus according to claim 1, wherein the hardware processors are configured to
issue a certificate of registration in the blockchain,
receive the attribute information including the certificate, and
obtain the evaluation information by additionally using the certificate included in the attribute information.

7. The information processing apparatus according to claim 6, wherein
the certificate allows an owner to be changed, and
the hardware processors are configured to obtain the evaluation information including a comparison result between the owner and a transmitter of the transmission data.

8. The information processing apparatus according to claim 1, wherein the hardware processors are configured to
receive the pieces of transmission data, and
obtain the evaluation information including information for evaluating validity of the whole pieces of transmission data.

9. The information processing apparatus according to claim 1, wherein the hardware processors are configured to receive the pieces of transmission data including transmission data from a first terminal device and transmission data from a second terminal device.

10. An information processing method implemented by a computer, the method comprising:
receiving, from a terminal device, one or more pieces of transmission data each including attribute information and registration data, the attribute information including first position and time information and second position and time information, the first position and time information indicating a position and a time at which the registration data is acquired, the second position and time information indicating a position and a time at which the registration data is transmitted;
registering, for each of the one or more pieces of transmission data, information based on the registration data included in the corresponding piece of transmission data and the attribute information included in the corresponding piece of transmission data in a blockchain;
obtaining, for each of the one or more pieces of transmission data registered in the blockchain, evaluation information for evaluating validity of the registration data included in the corresponding piece of transmission data by analyzing the attribute information included in the corresponding piece of transmission data; and
outputting the evaluation information.

11. A computer program product comprising a non-transitory computer readable recording medium on which programmed instruction executable by a computer are recorded, the instruction causing the computer to perform processing, the processing including:
receiving, from a terminal device, one or more pieces of transmission data each including attribute information and registration data, the attribute information including first position and time information and second position and time information, the first position and time information indicating a position and a time at which the registration data is acquired, the second position and time information indicating a position and a time at which the registration data is transmitted;
registering, for each of the one or more pieces of transmission data, information based on the registration data included in the corresponding piece of transmission data and the attribute information included in the corresponding piece of transmission data in a blockchain;
obtaining, for each of the one or more pieces of transmission data registered in the blockchain, evaluation information for evaluating validity of the registration data included in the corresponding piece of transmission data by analyzing the attribute information included in the corresponding piece of transmission data; and
outputting the evaluation information.
